(19) United States
(12) Patent Application Publication
(10) Pub. No.: US 2024/0212442 A1
(43) Pub. Date: Jun. 27, 2024

(54) TOURNAMENT PLAY ON VENDOR MACHINES

(71) Applicant: IGT, Las Vegas, NV (US)

(72) Inventors: Bradley BOUDREAU, Moncton (CA); Dwayne NELSON, Las Vegas, NV (US); Robert WALKER, Wakefield, RI (US); Theodore STROUT, Las Vegas, NV (US); Stephen CAPSTICK, Toronto (CA); Yan MEUNIER, Sackville (CA); Mark POLTAROWICZ, Moncton (CA)

(21) Appl. No.: 18/088,197

(22) Filed: Dec. 23, 2022

(51) Int. Cl. G07F 17/32

(52) U.S. Cl. CPC G07F 17/3239; G07F 17/323; G07F 17/3276

(57) ABSTRACT

A system configured to rank gameplay can include a processor circuit and a memory coupled to the processor circuit. The memory includes machine-readable instructions that, when executed by the processor circuit, cause the system to perform operations. The operation can include transmitting an indication of a start of an event to an electronic gaming machine (“EGM”). The operations can include, subsequent to transmitting the indication of the start of the event, receiving information associated with gameplay by a player from the EGM. The operations can further include determining a ranking associated with the player based on the information associated with the gameplay by the player. The operations can further include transmitting an indication of the ranking associated with the player.

### BACKGROUND

Embodiments described herein relate to electronic gaming machines (“EGMs”). The EGM can provide a prize to the player based on a wager and an outcome of the wagering game. An example of a wagering game includes a slot game in which, in response to receiving a wager from the player, one or more rows of symbols are revealed. A prize can be provided to the player based on the one or more rows of symbols including one or more winning combinations of symbols.

In some examples, a wagering game offered on one or more EGMs can be modified to provide a tournament. Players can compete within the tournament by simultaneously playing the same modified wagering game. A prize can be provided to a player that wins the tournament by having a highest score during the simultaneous play.

### SUMMARY

According to some embodiments, a system configured to rank gameplay is provided. The system includes a processor circuit and a memory coupled to the processor circuit. The memory includes machine-readable instructions that, when executed by the processor circuit, cause the system to perform operations. The operations include transmitting an indication of a start of an event to an electronic gaming machine (“EGM”). The operations further include, subsequent to transmitting the indication of the start of the event, receiving information associated with gameplay by a player from the EGM. The operations further include determining a ranking associated with the player based on the information associated with the gameplay by the player. The operations further include transmitting an indication of the ranking associated with the player.

According to other embodiments, an electronic gaming machine (“EGM”) configured to provide a tournament on top of an existing game is provided. The EGM can include a processor circuit and a memory coupled to the processor circuit. The memory includes machine-readable instructions that, when executed by the processor circuit, cause the EGM to perform operations. The operations include determining information associated with gameplay of the existing game on the EGM by a player. The operations further include transmitting the information associated with the gameplay on the EGM by the player to a tournament controller. The operations further include receiving an indication of a ranking of the player from the tournament controller.

According to various embodiments, EGMs, systems, methods, and non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIG. 3 is a flow chart illustrating an example of operations performed by a system according to some embodiments; and

FIG. 4 is a flow chart illustrating an example of operations performed by an electronic gaming machine (“EGM”) according to some embodiments.

### DETAILED DESCRIPTION

Tournaments can attract players by offering the opportunity for a bigger than normal or additional prize. However, in order for an EGM operator to implement a tournament, the EGM operator has to use games specifically modified to allow for tournament play. In some examples, modifying a game to allow for tournament play requires separate compliance certification from a regulator body. In additional or alternative examples, the tournament is limited to a bank of EGMs allowing for simultaneous tournament play. These limitations and burdens can outweigh the gain of hosting tournament play.

Embodiments described herein relate to a system for implementing tournament play on top of existing games (e.g., without modifying the existing games). In some embodiments, a system receives information from an EGM indicating gameplay by a player. The system can rank the gameplay of the player based on the information.

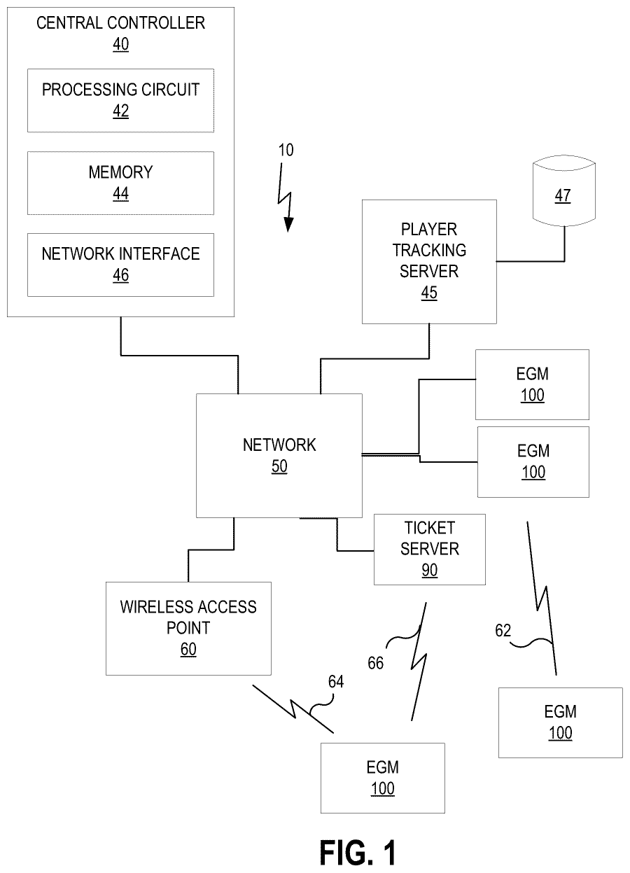

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

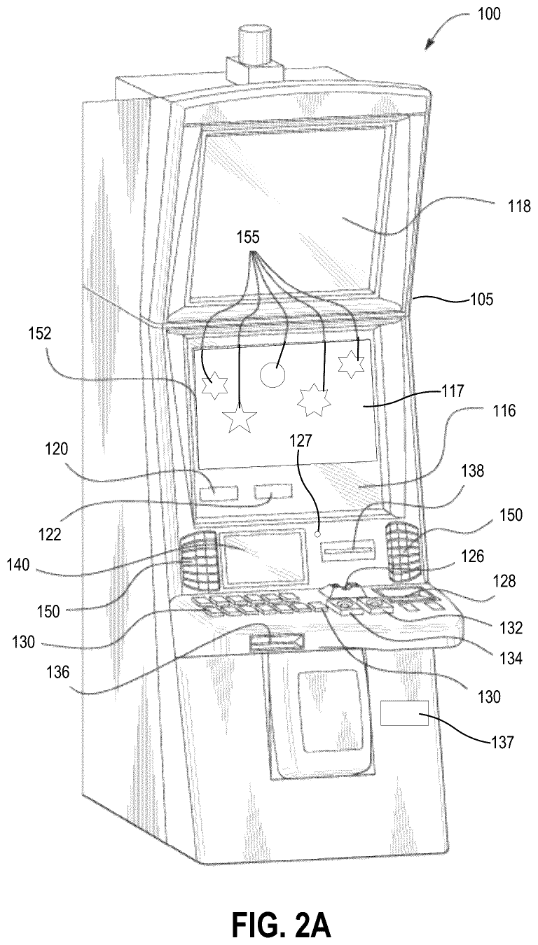

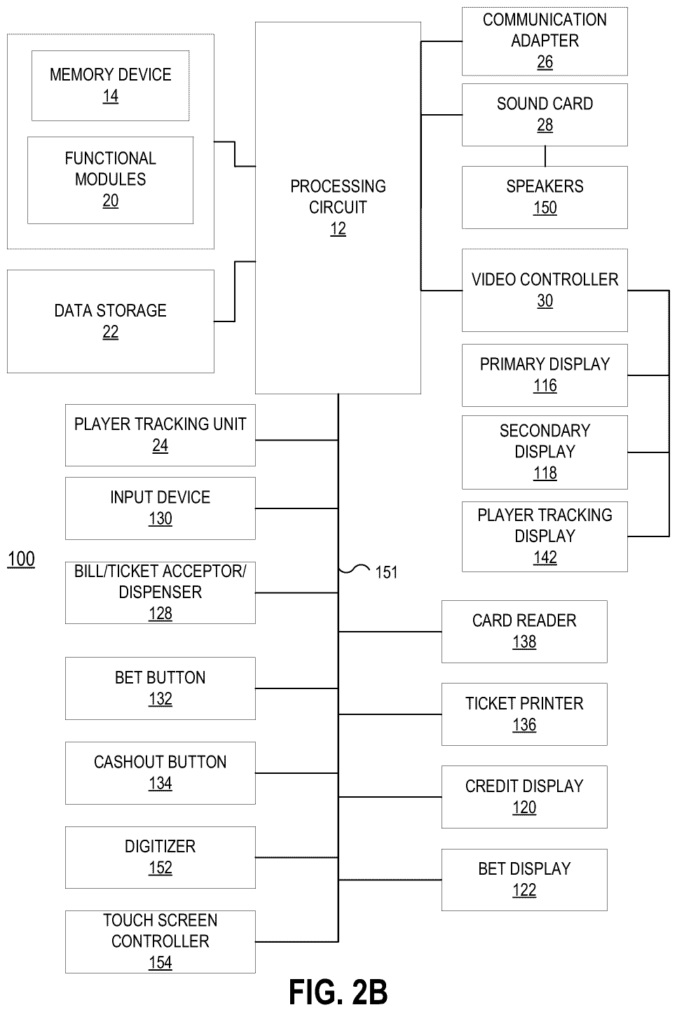

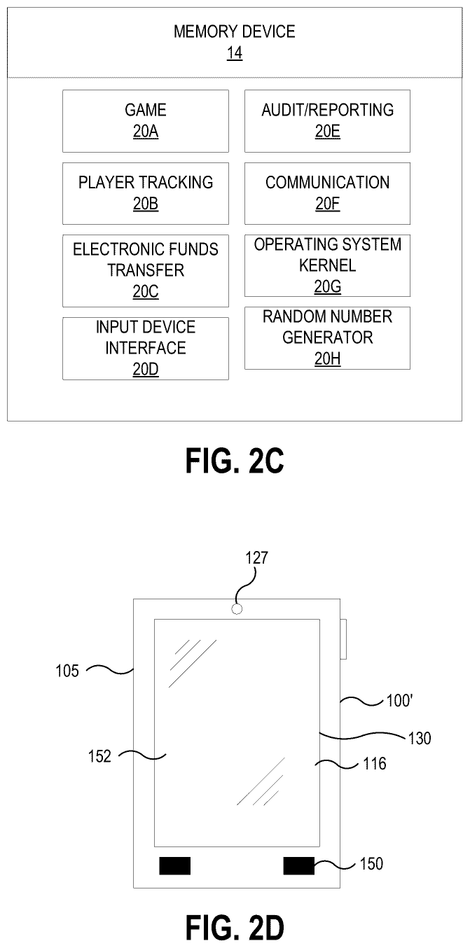

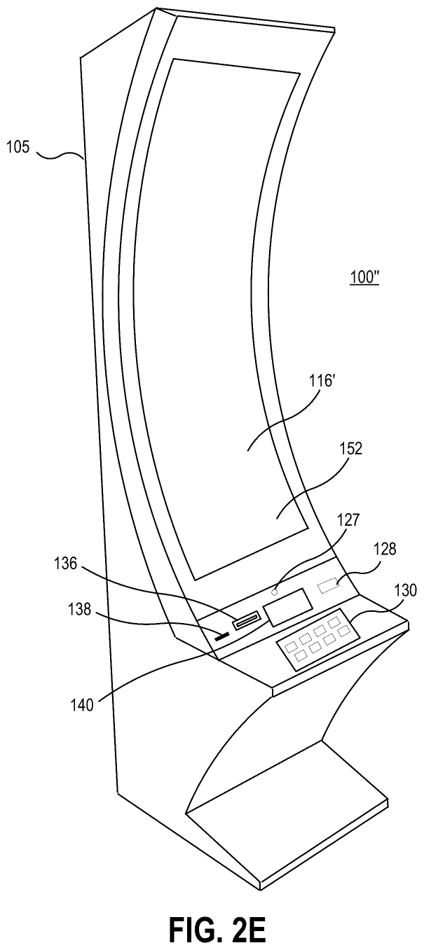

Embodiments herein may include different types of gaming devices. Various embodiments are illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller.” “microcontroller.” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FcRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

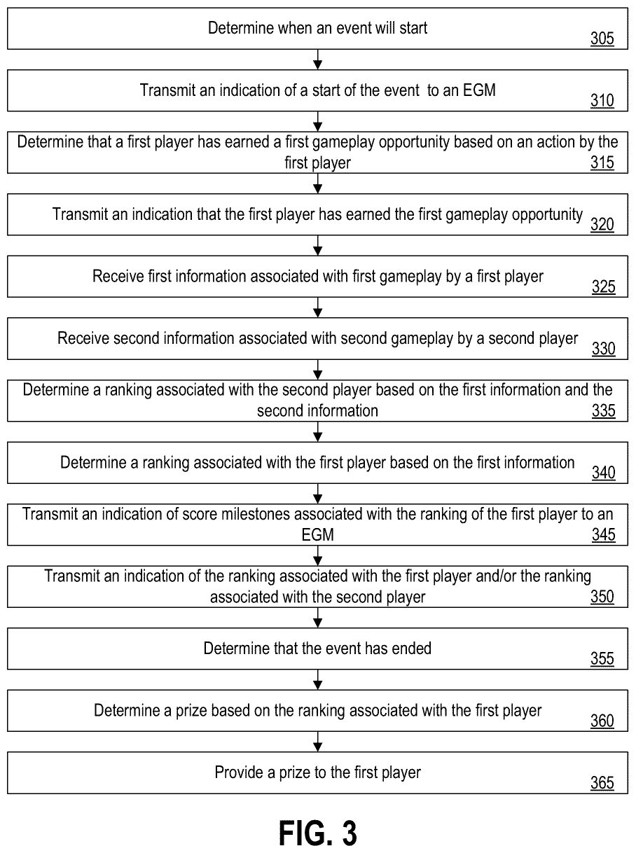

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments described herein relate to a system for ranking gameplay by a player. In some embodiments, the gameplay is first gameplay associated with a specific game and is ranked in comparison to second gameplay of the specific game by another player (or previous gameplays of the specific game by the player). In additional or alternative embodiments, the first gameplay is performed on a first EGM and the second EGM is performed on a second EGM that is different than the first EGM. In some examples, the second EGM is in a different physical location from the first EGM. In additional or alternative examples, the second EGM is a different type of device (e.g., a mobile device) than the first EGM (e.g., a traditional slot machine). In additional or alternative embodiments, the first gameplay is performed at a first time and the second gameplay is performed at a second time that tis different than the first time. In some examples, gameplay for a tournament may be limited to a predetermined number of spins of a specific game during a weekend. The first gameplay may include 20 consecutive spins on Friday and the second gameplay may include 15 spins on Saturday and 5 spins on Sunday. In additional or alternative embodiments, the first gameplay and the second gameplay are associated with different wagering amounts. For examples, the first gameplay may include 20 minimum wager (e.g., $0.05) spins of a slot machine game and the second gameplay may include 20 maximum wager (e.g., $0.50) spins of the slot machine game.

In additional or alternative embodiments, the first gameplay and the second gameplay are associated with different games. For example, the first gameplay may be associated with play of a first slot machine game and the second gameplay may be associated with a second slot machine game. In additional or alternative embodiments, the first gameplay and the second gameplay are associated with different types of games. For example, the first gameplay may be associated with a slot machine game and the second gameplay may be associated with a table game (e.g., an electronic table game or a table game with electronically recorded gameplay).

In additional or alternative embodiments, ranking of the first gameplay relative to the second gameplay may be normalized so as to take into account differences between the first gameplay and the second gameplay. In some examples, the first gameplay may be given a score per time spent on the gameplay. In additional or alternative examples, the first gameplay may be given a score per total money spent on the gameplay.

In additional or alternative embodiments, a player may submit one or more gameplays to be ranked. In some examples, each gameplay is limited to a specific window of time spent, money wagered, spins used, and/or a real-world time window. In additional or alternative embodiments, a player may be provided with a predetermined number of submissions (e.g., one, a specific number, or unlimited) that can be used to submit gameplay for ranking. In additional or alternative embodiments, the player may earn submissions, for example, via normal gameplay, special prizes, or loyalty points.

In additional or alternative embodiments, the system can rank the gameplay as part of a tournament and award prizes based on ranking. In some examples, the tournament can be open to all players. In additional or alternative examples, the tournament can be invite-only or a player may pay for entry into the tournament. In additional or alternative embodiments, the tournament can be divided into divisions based on a variety of factors (e.g., a specific game, a specific type of game, a specific EGM, a specific casino, and a specific wager amount). In additional or alternative embodiments, the tournament can include a bracket such that a group of one or more players compete directly against another group of one or more players to advance in the tournament.

In additional or alternative embodiments, the system can receive an indication of gameplay by a player from the EGM on which the gameplay was performed. In some examples, the system uses the gameplay to determine a score that is compared with other scores to determine a ranking. In additional or alternative examples, the indication of the gameplay includes a score determined by the EGM that the system can use to determine the ranking. The gameplay may include an indication of at least one of: an amount wagered; a number of spins; an amount of time played; an amount won; a number of wins in a row; and a number of losses in a row, which can be used to calculate a score.

In additional or alternative embodiments, the system can provide information associated with the rankings (and/or the tournament) to individual EGMs to be provided (e.g., displayed) to a player. In some examples, the system provides an indication of each ranking or a best ranking associated with the player to an EGM. In additional or alternative examples, the system provides an indication of a current score and/or ranking associated with gameplay still in progress by the player to the EGM. In additional or alternative examples, the system provides an indication of score milestones associated with a specific score (e.g., a top ranked score) to the EGM. The EGM can provide an in indication of a difference between the specific score and a current score of gameplay in progress by the player.

In some examples, entries in a tournament may each include 10 spins of a specific game. The system may provide an EGM with an indication of a cumulative score that a highest ranking player obtained after each spin during a respective tournament entry. The EGM can display an indicator showing whether current gameplay by a player is ahead or behind the cumulative score after each spin of the current gameplay.

In additional or alternative embodiments, gameplay (e.g., tournament entries) can be weighed based on when they were submitted, a loyalty status of a player, a type of game associated with the gameplay, an amount wagered during the gameplay, or any other suitable factor.

The embodiments described herein can permit ranking of gameplay (and implementation of associated tournaments) without modifying the underlying games. In some examples, a player may be playing a specific game on an EGM without generating any gameplay entries then in response to a triggering event (without any modification to the specific game) the player may continue playing the specific game and generate gameplay for entry in a tournament. In additional or alternative examples, the triggering event can include the player making an input to the EGM separate from the specific game. In additional or alternative examples, the triggering event can include a gameplay entry window beginning.

In additional or alternative embodiments, the system and/or the EGMs can attract and retain players by providing indications of the availability of a ranking (or tournament) to players. In some examples, the system can display, via an EGM, an indication that a player has a gameplay opportunity. In additional or alternative examples, the system can display, via an EGM, an indication that a player would have obtained a specific ranking if previous gameplay had been ranked. In additional or alternative examples, the system can display, via an EGM, an indication that a player has started a gameplay entry and explain how to complete the gameplay entry.

FIG. 3 illustrates examples of operations performed by a system configured to rank gameplay.

At block 305, processing circuit 42 determines when an event will start. In some embodiments, the system determines that the event has started. In additional or alternative embodiments, the system determines a time at which the event will start.

At block 310, processing circuit 42 transmits, via network interface 46, an indication of a start of the event to an EGM. In some embodiments, the indication includes an indication that the vent has started. In additional or alternative embodiments, the indication includes an indication of the time at which the event will start. In additional or alternative embodiments, the indication includes an indication of an amount of time until the event starts.

At block 315, processing circuit 42 determines that a first player has earned a first gameplay opportunity based on an action by the first player. In some embodiments, the gameplay opportunity includes at least one of: an amount of time in which to play a qualifying game; and a number of spins to use to play the qualifying game.

At block 320, processing circuit 42 transmits, via network interface 46, an indication that the first player has earned the first gameplay opportunity.

At block 325, processing circuit 42 receives, via network interface 46, first information associated with first gameplay by a first player. In some embodiments, receiving the information associated with the first gameplay by the first player includes receiving the information associated with the first gameplay by the first player from a first EGM.

At block 330, processing circuit 42 receives, via network interface 46, second information associated with second gameplay by a second player. In some embodiments, receiving the information associated with the second gameplay by the second player includes receiving the information associated with the second gameplay by the second player from a second EGM that is different from the first EGM.

In additional or alternative embodiments, the first gameplay by the first player is associated with a first game and the second gameplay by the second player is associated with a second game that is different than the first game.

In additional or alternative embodiments, the first gameplay by the first player is associated with a first type of game and the second gameplay by the second player is associated with a second type of game that is different than the first type of game. The first type of game or the second type of game includes at least one of: a slot machine; a table game; and a lottery game.

In additional or alternative embodiments, the first gameplay and the second gameplay are both associated with at least one of: a predetermined number of spins; a time window of a predetermined length; and a predetermined wager amount. In some examples, the first gameplay and the second gameplay are asynchronous.

At block 335, processing circuit 42 determines a ranking associated with the second player based on the first information and the second information.

At block 340, processing circuit 42 determines a ranking associated with the first player based on the first information. In some embodiments, determining the ranking associated with the first player includes determining the ranking associated with the first player based on the first information associated with the first gameplay by the first player and based on the second information associated with the second gameplay by the second player.

In additional or alternative embodiments, determining the ranking associated with the first player includes: determining a combined score based on the information associated with the first gameplay by the first player and based on the information associated with the second gameplay by the second player; and determining the ranking associated with the first player based on the combined score.

In additional or alternative embodiments, the information associated with the gameplay by the player (e.g., the first player or the second player) includes at least one of: an indication of an amount wagered; an indication of an amount won; an indication of a number of games played; an indication of a number of games won in a row; an indication of a number of games lost in a row; an indication of a score earned by the gameplay; an indication of an identity of the player; and an indication of a tier status (e.g., a loyalty status or casino membership status) of the player.

In additional or alternative embodiments, determining the ranking associated with the player based on the information associated with the gameplay by the player includes determining a normalized ranking. In some examples, the information associated with gameplay by the player comprises an amount won and an amount per wager. Determining the ranking associated with the player based on the information associated with the gameplay by the player includes determining a score based on dividing the amount won by the amount per wager; and determining the ranking based on the score. This can allow gameplay associated with different bet sizes to have comparable scores despite the fact that gameplay with higher bet sizes to generally have higher amounts won than gameplay with lower bet sizes. Similar adjustments can be made to make gameplay associated with different total amounts wagered, total time spent playing, and total spins used playing comparable.

At block 345, processing circuit 42 transmits, via network interface 46, an indication of score milestones associated with the ranking of the player to an EGM.

At block 350, processing circuit 42 transmits, via network interface 46, an indication of the ranking associated with the first player and/or the ranking associated with the second player. In some embodiments, transmitting the indication of the ranking associated with the player includes transmitting the indication of a plurality of players including the player to a plurality of EGMs.

At block 355, processing circuit 42 determines that the event has ended.

At block 360, processing circuit 42 determines a prize based on the ranking associated with the first player.

At block 365, processing circuit 42 provides, via network interface 46, a prize to the first player.

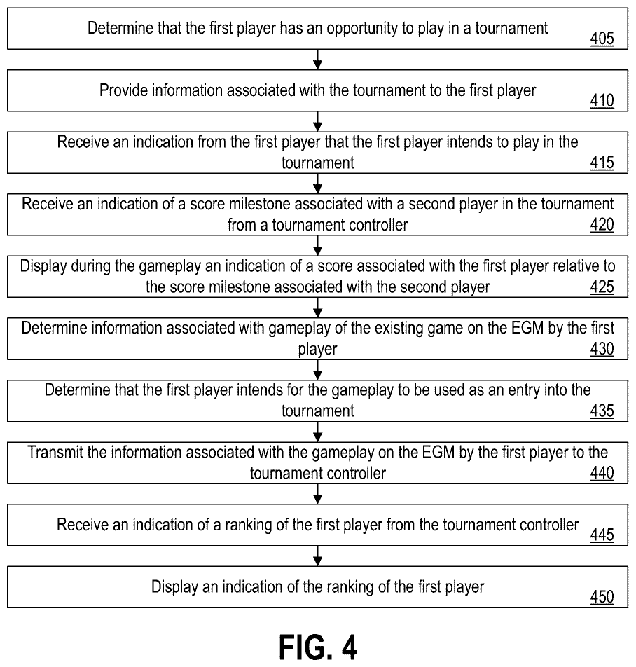

FIG. 4 illustrates examples of operations performed by an EGM configured to provide a tournament on top of an existing game.

At block 405, processing circuit 12 determines that the first player has an opportunity to play in a tournament.

At block 410, processing circuit 12 provides information associated with tournament to the first player. In some embodiments, providing the information includes displaying, via video controller 30, the information. In additional or alternative embodiments, providing the information includes outputting the information via audio, visual, or haptic output devices. In some examples, the information includes at least one of: an amount of time before the tournament starts; an amount of time before the tournament ends; and an amount of time before a gameplay session ends.

At block 415, processing circuit 12 receives, via communication adapter 26, an indication from the first player that the first player intends to play in the tournament.

At block 420, processing circuit 12 receives, via communication adapter 26, an indication of a score milestone associated with a second player in the tournament from a tournament controller.

At block 425, processing circuit 12 displays, via video controller 30, during the gameplay, an indication of a score associated with the first player relative to the score milestone associated with the second player.

At block 430, processing circuit 12 determines information associated with gameplay of the existing game on the EGM by the first player. In some embodiments, determining the information associated with the gameplay on the EGM by the player includes determining at least one of: an indication of an amount wagered; an indication of an amount won; an indication of a number of games played; an indication of a number of games won in a row; an indication of a number of games lost in a row; an indication of a score earned by the gameplay; an indication of an identity of the player; and an indication of a tier status of the player. In additional or alternative embodiments, the gameplay on the EGM by the player is limited to at least one of: a predetermined number of games played; a time window of a predetermined length; and a predetermined amount wagered.

In additional or alternative embodiments, determining the information associated with the gameplay on the EGM by the player includes determining the information associated with play of the existing game on the EGM without modifying the existing game.

At block 435, processing circuit 12 determines that the first player intends for the gameplay to be used as an entry into the tournament. In some embodiments, determining the information associated with the gameplay on the EGM by the player includes determining the information associated with the gameplay on the EGM by the player in response to receiving the indication from the player that the player intends to play in the tournament.

At block 440, processing circuit 12 transmits, via communication adapter 26, the information associated with the gameplay on the EGM by the first player to the tournament controller.

At block 445, processing circuit 12 receives, via communication adapter 26, an indication of a ranking of the first player from the tournament controller.

At block 450, processing circuit 12 displays, via video controller 30, an indication of the ranking of the first player.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system configured to rank gameplay, the system comprising:
a processor circuit; and
a memory coupled to the processor circuit, the memory comprising machine-readable instructions that, when executed by the processor circuit, cause the system to perform operations comprising:
transmitting an indication of a start of an event to an electronic gaming machine (“EGM”),
subsequent to transmitting the indication of the start of the event, receiving information associated with gameplay by a player from the EGM;
determining a ranking associated with the player based on the information associated with the gameplay by the player; and
transmitting an indication of the ranking associated with the player.

2. The system of claim 1, wherein the player is a first player,
wherein the gameplay comprises a first gameplay,
the operations further comprising:
receiving information associated with second gameplay by a second player,
wherein determining the ranking associated with the player comprises determining the ranking associated with the first player based on the information associated with the first gameplay by the first player and based on the information associated with the second gameplay by the second player.

3. The system of claim 2, wherein determining the ranking associated with the first player comprises:
determining a combined score based on the information associated with the first gameplay by the first player and based on the information associated with the second gameplay by the second player; and
determining the ranking associated with the first player based on the combined score.

4. The system of claim 2, the operations further comprising:
determining a ranking associated with the second player relative to the first player based on a comparison of the information associated with the first gameplay by the first player and the information associated with the second gameplay by the second player,
wherein transmitting the indication of the ranking associated with the player comprises transmitting an indication of the ranking of the first player and/or the ranking of the second player.

5. The system of claim 2, wherein receiving the information associated with the first gameplay by the first player comprises receiving the information associated with the first gameplay by the first player from a first electronic gaming machine (“EGM”), and
wherein receiving the information associated with the second gameplay by the second player comprises receiving the information associated with the second gameplay by the second player from a second EGM that is different from the first EGM.

6. The system of claim 2, wherein the first gameplay by the first player is associated with a first game, and
wherein the second gameplay by the second player is associated with a second game that is different than the first game.

7. The system of claim 2, wherein the first gameplay by the first player is associated with a first type of game,
wherein the second gameplay by the second player is associated with a second type of game that is different than the first type of game, and
wherein the first type of game or the second type of game comprises at least one of:
a slot machine;
a table game; and
a lottery game.

8. The system of claim 2, wherein the first gameplay and the second gameplay are both associated with at least one of:
a predetermined number of spins;
a time window of a predetermined length; and
a predetermined wager amount, and
wherein the first gameplay and the second gameplay are asynchronous.

9. The system of claim 1, wherein the information associated with the gameplay by the player comprises at least one of:
an indication of an amount wagered;
an indication of an amount won;
an indication of a number of games played;
an indication of a number of games won in a row;
an indication of a number of games lost in a row;
an indication of a score earned by the gameplay;
an indication of an identity of the player; and
an indication of a tier status of the player.

10. The system of claim 1, the operations further comprising:
determining that the player has earned a gameplay opportunity based on an action by the player; and
transmitting an indication that the player has earned the gameplay opportunity,
wherein the gameplay opportunity comprises at least one of:
an amount of time in which to play a qualifying game; and
a number of spins to use to play the qualifying game.

11. The system of claim 1, the operations further comprising:
determining that the event has ended;
subsequent to determining that the event has ended, determining a prize based on the ranking associated with the player; and
providing the prize to the player.

12. The system of claim 1, the operations further comprising:
transmitting an indication of score milestones associated with the ranking of the player to an electronic gaming machine (“EGM”) configured to provide gameplay opportunities.

13. The system of claim 1, wherein determining the ranking associated with the player based on the information associated with the gameplay by the player comprises determining a normalized ranking.

14. The system of claim 1, wherein the information associated with gameplay by the player comprises an amount won and an amount per wager,
wherein determining the ranking associated with the player based on the information associated with the gameplay by the player comprises:
determining a score based on dividing the amount won by the amount per wager; and
determining the ranking based on the score.

15. An electronic gaming machine (“EGM”) configured to provide a tournament on top of an existing game, the EGM comprising:
a processor circuit; and
a memory coupled to the processor circuit, the memory comprising machine-readable instructions that, when executed by the processor circuit, cause the EGM to perform operations comprising:
determining information associated with gameplay of the existing game on the EGM by a player;
transmitting the information associated with the gameplay on the EGM by the player to a tournament controller; and
receiving an indication of a ranking of the player from the tournament controller.

16. The EGM of claim 15, the operations further comprising:
determining that the player intends for the gameplay to be used as an entry into the tournament,
wherein determining the information associated with the gameplay on the EGM by the player comprises determining at least one of:
an indication of an amount wagered;
an indication of an amount won;
an indication of a number of games played;
an indication of a number of games won in a row;
an indication of a number of games lost in a row;
an indication of a score earned by the gameplay;
an indication of an identity of the player; and
an indication of a tier status of the player, and
wherein the gameplay on the EGM by the player is limited to at least one of:
a predetermined number of games played;
a time window of a predetermined length; and
a predetermined amount wagered.

17. The EGM of claim 15, wherein determining the information associated with the gameplay on the EGM by the player comprises determining the information associated with play of the existing game on the EGM without modifying the existing game.

18. The EGM of claim 15, the operations further comprising:
determining that the player has an opportunity to play in the tournament;
displaying an indication of the opportunity to play in the tournament to the player;
receiving an indication from the player that the player intends to play in the tournament; and
displaying an indication of the ranking of the player,
wherein determining the information associated with the gameplay on the EGM by the player comprises determining the information associated with the gameplay on the EGM by the player in response to receiving the indication from the player that the player intends to play in the tournament.

19. The EGM of claim 15, the operations further comprising:
providing, to the player, an indication of at least one of:
an amount of time before the tournament starts;
an amount of time before the tournament ends; and
an amount of time before a gameplay session ends.

20. The EGM of claim 15, wherein the player is a first player,
the operations further comprising:
receiving an indication of a score milestone associated with a second player in the tournament from the tournament controller; and
displaying during the gameplay an indication of a score associated with the player relative to a score milestone associated with the second player.
